(19) United States
(12) Patent Application Publication
(10) Pub. No.: US 2019/0386309 A1
(43) Pub. Date: Dec. 19, 2019

(54) ELECTRODE AND SECONDARY BATTERY USING RADICAL POLYMER

(71) Applicants: NEC CORPORATION, Tokyo (JP); KURARAY CO., LTD., Kurashiki-shi, Okayama (JP)

(72) Inventors: Shigeyuki IWASA, Tokyo (JP); Takanori NISHI, Tokyo (JP); Hideharu IWASAKI, Okayama (JP); Jun-Sang CHO, Okayama (JP)

(73) Assignees: NEC Corporation, Tokyo (JP); Kuraray Co., Ltd., Kurashiki-shi, Okayama (JP)

(21) Appl. No.: 16/479,295

(22) PCT Filed: Jan. 19, 2018
(86) PCT No.: PCT/JP2018/001614

§ 371 Date: Jul. 19, 2019

(30) Foreign Application Priority Data
Jan. 20, 2017 (JP) 2017-008484

(51) Int. Cl. H01M 4/60; H01M 10/0525; C08F 220/36

(52) U.S. Cl. CPC H01M 4/604; C08F 220/36; H01M 10/0525

(57) ABSTRACT

In order to provide an organic radical battery excellent in the high output performance and the discharge characteristic at large currents, an electrode using, as an electrode active material, a copolymer having a repeating unit having a nitroxide radical site represented by the formula (1-a) and a repeating unit having carboxy-lithium represented by the formula (1-b) in the range of x satisfying 0.1 to 10 is used for the organic radical battery.

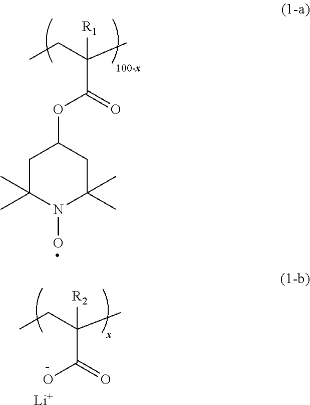

### TECHNICAL FIELD

The present invention relates to an electrode and a secondary battery using a radical polymer as an electrode active material.

### BACKGROUND ART

In the 1990s, cellular phones drastically came into wide use along with development of communications systems. From the 2000s on, a variety of portable electronic devices such as laptop computers, tablet terminals, smart phones and portable game machines have spread. The portable electronic devices have become essential to businesses and daily lives. For power sources of the portable electronic devices, secondary batteries are used. The secondary batteries are always demanded to have a high energy density meaning that one-time charge allows long usage thereof. On the other hand, the portable electronic devices are, since diversification of functions and shapes thereof is advancing, increasingly demanded to have various properties such as high power output, large current discharge (high rate discharge), short time charge (high rate charge), size reduction, weight reduction, flexibility and high safety.

Patent Literature 1 discloses a secondary battery utilizing redox of a stable radical compound for charge and discharge. The secondary battery is one called an organic radical battery. The stable radical compound is, since being an organic material constituted of light-weight elements, expected as a technology providing light-weight batteries. Non-Patent Literature 1 and Non-Patent Literature 2 report that organic radical batteries can be charged and discharged at large currents and have high power densities. Further Non-Patent Literature 2 also describes that the organic radical battery can be reduced in thickness and has flexibility.

In the organic radical batteries, a radical polymer having a stable radical such as poly(2,2,6,6-tetramethylpiperidinyl-N-oxyl-4-yl methacrylate) (PTMA) (formula (2)) is used as an electrode active material.

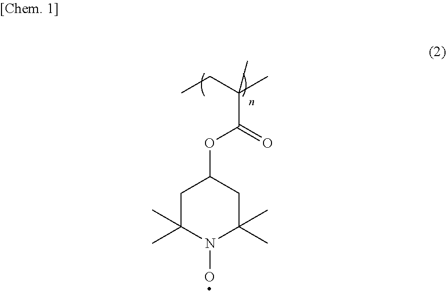

PTMA has a nitroxyl radical as a stable radical species, but the nitroxyl radical takes, in the charged state (oxidized state), an oxoammonium cation structure, and in the discharged state (reduced state), a nitroxyl radical structure. Then, the redox reaction (reaction scheme (I)) can be repeated stably. The organic radical batteries can repeat charge and discharge by utilizing the redox reaction.

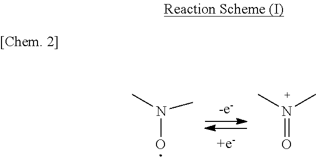

Conventional secondary batteries such as Li ion batteries, lead storage batteries and nickel hydrogen batteries have used heavy metal materials and carbon materials as their electrode active material. These electrode active materials, though having wettability to electrolytes, do not absorb the electrolytes themselves and then never change to a soft state. On the other hand, Non-Patent Literature 2 describes that PTMA (formula (2)) being an electrode active material of the organic radical battery, since having high affinity for an organic solvent, absorbs an electrolyte and becomes gel in the battery. Further Non-Patent Literature 3 reports that the gel has a charge transportation capability by charge self-exchange between the nitroxyl radical and the oxoammonium ion.

### CITATION LIST

### Patent Literature

Patent Literature 1: JP2002-304996A

### Non-Patent Literature

Non-Patent Literature 1: Nakahara and five others, Journal of Power Sources, Vol. 163, pp. 1110-1113 (2007)
Non-Patent Literature 2: Iwasa and three others, NEC Technical Journal, Vol. 7, pp. 105-106 (2012)
Non-Patent Literature 3: Nakahara and two others, Journal of Material Chemistry, Vol. 22, pp. 13669-133664 (2012)

### SUMMARY OF INVENTION

### Technical Problem

The charge and discharge mechanism of a positive electrode of a PTMA organic radical battery is shown in FIG. 1. In charge and discharge of the positive electrode of the organic radical battery, on the surface of a current collector or carbon (conductivity-imparting agent), a redox reaction of PTMA and the charge transportation in the PTMA gel to supply reaction species of the redox reaction to the surface of the current collector or the carbon simultaneously occur. The charge transportation is an important element of the charge and discharge mechanism of the positive electrode of the organic radical battery using PTMA. The charge transportation in the gel is a thermal diffusion phenomenon and the velocity is conceivably relatively slow. That is, the slowness of the charge transportation in the PTMA gel becomes the cause of reducing high power output performance and the discharge characteristic at large currents, which organic radical batteries intrinsically have. Then, the state of the PTMA gel conceivably has a large effect on the charge transportation capability.

Then, the present invention has an object to improve the high power output performance of an organic radical battery and the discharge characteristic thereof at large currents by bettering the gel state of a polymer radical compound.

### Solution to Problem

As described above, the slowness of the charge transportation in the PTMA gel may possibly reduce the performance regarding high power output, large-current discharge and short-time charge of the organic radical battery. In the present invention, it has been found that the gel state of a radical polymer compound such as PTMA is modified by introducing carboxy Li to the radical polymer compound, so that properties regarding high power output, large-current discharge and short-time charge of the organic radical battery can be improved.

That is, according to one aspect of the present invention, provided is an electrode using, as an electrode active material, a copolymer having a repeating unit having a nitroxide radical site represented by the following formula (1-a) and a repeating unit having carboxy-lithium represented by the following formula (1-b) in the range of x satisfying 0.1 to 10.

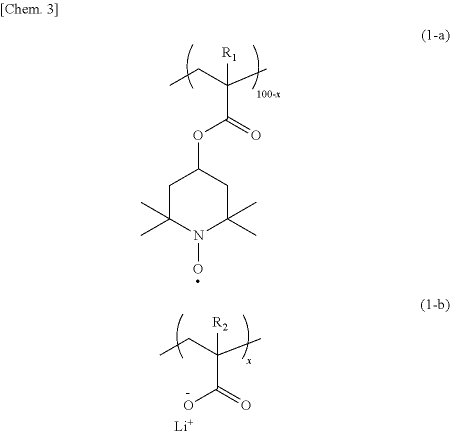

In the formulas (1-a) and (1-b), R₁ and R₂ each independently represent hydrogen or a methyl group; and 100−x:x represents a molar ratio of the repeating units in the copolymer.

The copolymer is preferably a binary copolymer represented by the following formula (1).

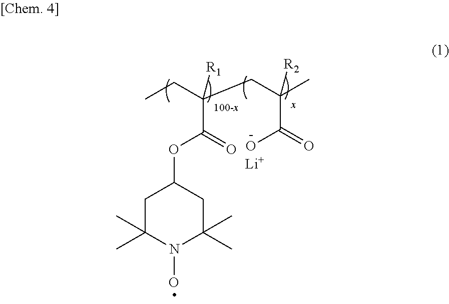

In the formula (1), R₁ and R₂ each independently represent hydrogen or a methyl group; and 100−x:x represents a molar ratio of the repeating units in the copolymer, and x is 0.1 to 10.

Further, the copolymer is preferably a crosslinked copolymer further having a crosslinked structure represented by the following formula (7A) or a crosslinked structure represented by the following formula (8A).

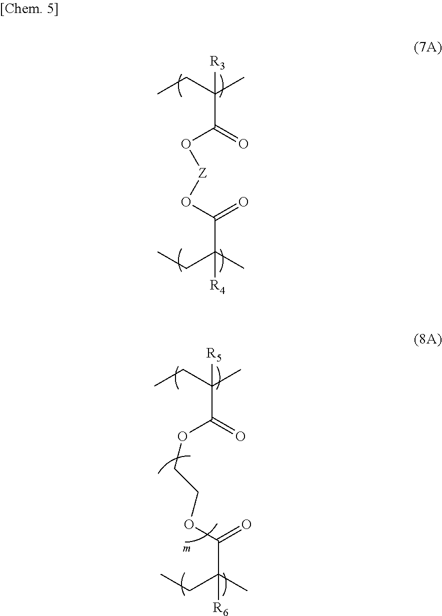

In the formulas (7A) and (8A), R₃ to R₆ each independently represent hydrogen or a methyl group; Z represents an alkylene chain having 2 to 12 carbon atoms; and n represents an integer of 2 to 12.

Further according to another aspect of the present invention, provided is a secondary battery using the above electrode active material for a positive electrode or a negative electrode, or for both positive and negative electrodes.

### Advantageous Effects of Invention

According to the present invention, an “organic radical battery” excellent in the high power output and the high rate discharge characteristic can be obtained.

### BRIEF DESCRIPTION OF DRAWINGS

FIG. 1 is a conceptual diagram of the charge and discharge mechanism of a positive electrode of a conventional organic radical battery.

FIG. 2 is a perspective view of a laminate-type secondary battery according to an example embodiment.

FIG. 3 is a cross-sectional view of the laminate-type secondary battery according to the example embodiment.

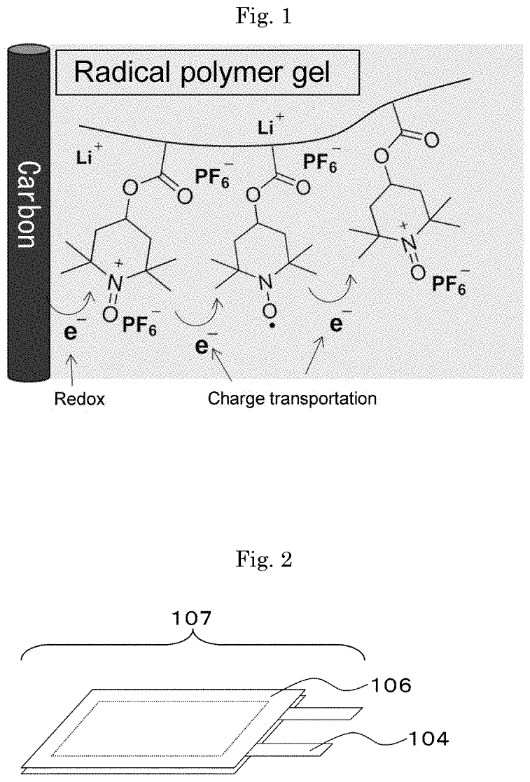

### DESCRIPTION OF EMBODIMENTS

Hereinafter, an electrode and a secondary battery using the electrode active material according to the present invention will be described by way of example embodiments. The present invention, however, is not limited to the following description, and any changes and modifications may be made in the scope not departing from the gist of the present invention.

[Copolymer]

In an electrode according to the present example embodiment, an electrode active material comprises a copolymer having a repeating unit having a nitroxide radical site represented by the following formula (1-a) and a repeating unit having carboxy-lithium represented by the following formula (1-b) in the range of x satisfying 0.1 to 10.

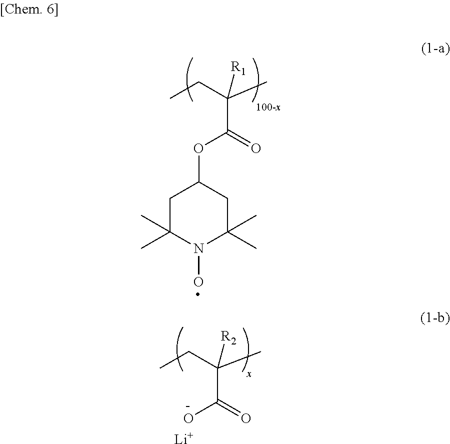

In the formulas (1-a) and (1-b), R₁ and R₂ each independently represent hydrogen or a methyl group; and 100−x:x represents a molar ratio of the repeating units in the copolymer.

With the total amount of the repeating unit having a nitroxide radical site represented by the formula (1-a) and the repeating unit having carboxy-lithium represented by the formula (1-b) being taken as 100 mol %, when the repeating unit of the formula (1-b) contained exceeds 10 mol %, the proportion of the repeating unit of the formula (1-a) becomes low, causing a decrease in the battery capacity. On the other hand, when the repeating unit of the formula (1-b) is less than 0.1 mol %, the modification of the gel state cannot be achieved.

The proportion (x) of the repeating unit of the formula (1-b) is preferably 0.5 mol % or higher and more preferably 1.0 mol % or higher. Then, the proportion (x) is preferably 5.0 mol % or lower and more preferably 2.0 mol % or lower.

The copolymer according to the present example embodiment may comprise repeating units other than the formulas (1-a) and (1-b) as constitutional units in the range not impairing advantageous effects of the present invention. The other constitutional units include non-ionizing repeating units such as alkyl (meth)acrylates, and units originated from a polyfunctional monomer capable of forming a crosslinked structure. The copolymer according to the present example embodiment can be a straight-chain, branched-chain or crosslinked state. In the crosslinked state, the dissolving-out of the copolymer into an electrolyte in the case of long-time usage can be suppressed. That is, crosslinking can improve the durability to the electrolyte to make a secondary battery excellent in the long-term reliability. In the case of a conventional crosslinked copolymer, a measure for betterment of the charge transportation capability in a radical polymer gel is, only, simple control of the degree of crosslinking in balance with suppression of the solubility of the polymer, and the betterment of the charge transportation capability in the polymer gel has a limit. By contrast, in the present invention, even when the copolymer is made to be a crosslinked copolymer, imparting a lithium base (carboxy-lithium) to the polymer skeleton enables polymer physical properties to be modified (imparting of Li ion conductivity, betterment of affinity for an electrolyte and a conductive auxiliary agent), and as a result leads to betterment of the charge transportation capability in a polymer gel effective for the large-current charge and discharge characteristic of a battery.

The other constitutional units are, per 100 mol % in total of the repeating units of the formulas (1-a) and (1-b), preferably 5 mol % or less and more preferably 1 mol % or less.

From the viewpoint of providing a high-capacity “organic radical secondary battery”, the copolymer is preferably a binary copolymer represented by the following formula (1), containing no other constitutional units.

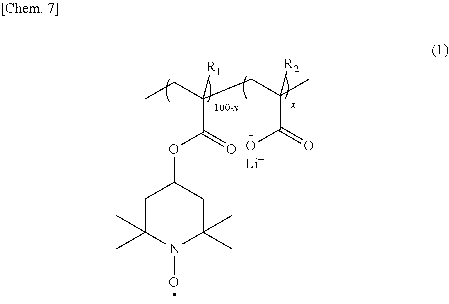

In the formula (1), R₁ and R₂ each independently represent hydrogen or a methyl group; and 100−x:x represents a molar ratio of the repeating units in the copolymer, and x is 0.1 to 10.

The molecular weight of the copolymer according to the present example embodiment is not especially limited, and when a secondary battery is constituted, the copolymer preferably has a molecular weight enough not to dissolve in its electrolyte. The molecular weight not dissolving in the electrolyte is, though depending on the kinds and the combinations of organic solvents in the electrolyte, in weight-average molecular weight, generally 1,000 or higher, preferably 10,000 or higher and still more preferably 20,000 or higher. In the case where the copolymer has a very high molecular weight, since the polymer comes to be unable to absorb the electrolyte and does not take a gel state, the weight-average molecular weight is preferably 1,000,000 or lower and more preferably 200,000 or lower. The weight-average molecular weight can be measured by a known method such as gel permeation chromatography (GPC). Then in the case where the copolymer is a crosslinked copolymer and does not dissolve in a GPC solvent, the molecular weight may be determined as a deemed molecular weight determined from the weight-average molecular weight of a corresponding linear copolymer according to the degree of crosslinking.

A synthesis method of the copolymer represented by the formula (1) of the present example embodiment will be described by using a copolymer having a structure of the formula (3) as an example.

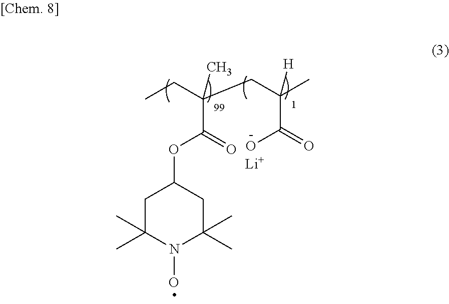

A synthesis route of the copolymer of the formula (3) is shown as a reaction scheme (II). First, a methacrylate (formula (4)) having a secondary amine and acrylic acid are radically copolymerized by a radical polymerization initiator such as azoisobutyronitrile (AIBN) in a solvent such as tetrahydrofuran. By the radical copolymerization, a copolymer of the formula (5) is obtained. At this time, the molar ratio of the methacrylate having a secondary amine to acrylic acid is made to be equal to the molar ratio of the repeating units of the copolymer. In the case of the copolymer of the formula (3), the molar ratio of the methacrylate having a secondary amine to acrylic acid is made to be 99:1. Then, by oxidizing secondary amine sites of the copolymer represented by the formula (5) with an oxidizing agent such as a hydrogen peroxide aqueous solution or 3-chloroperbenzoic acid, the secondary amine sites are converted to nitroxide radicals to thereby obtain a copolymer represented by the formula (6). Finally, by an acid-base reaction using a 10-wt % lithium methoxide methanol solution or the like, carboxyl groups of the copolymer represented by the formula (6) are lithiated to carboxy-lithium to thereby obtain the copolymer represented by the formula (3).

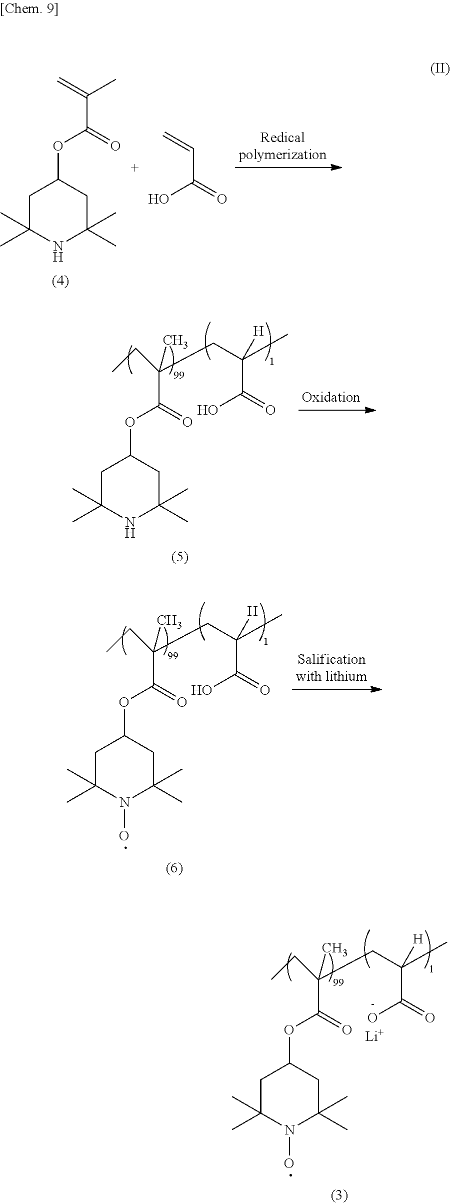

The form of the copolymer can be either of a random copolymer and a block copolymer, but is preferably a copolymer dispersedly containing the repeating unit of the formula (1-b). Then, since the proportion of the repeating unit of the formula (1-b) is low, a prepolymer having a repeating unit of a precursor structure of the formula (1-a) can be made and then reacted with a precursor monomer of the formula (1-b).

The synthesis of a crosslinked material of the copolymer according to the present example embodiment can be carried out by adding a small amount of a crosslinking agent having a plurality of polymerizable groups such as bifunctional (meth)acrylates in the radical polymerization of a (meth)acrylate having a secondary amine with (meth)acrylic acid. As the bifunctional (meth)acrylate, a compound having an alkylene chain represented by the formula (7) or a compound having an ethylene oxide chain represented by the formula (8) can be used.

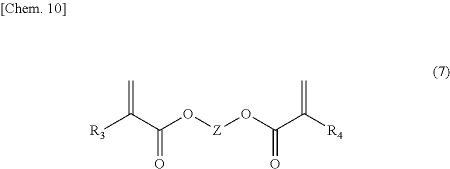

In the formula (7), R₃ and R₄ each independently represent hydrogen or a methyl group; and Z represents an alkylene chain having 2 to 12 carbon atoms.

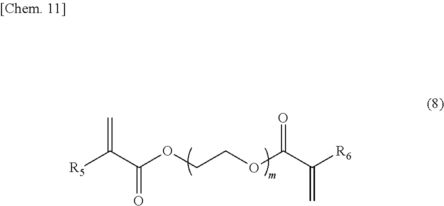

In the formula (8), R₅ and R₆ each independently represent hydrogen or a methyl group; and n represents 2 to 12.

As a result, a crosslinked copolymer having, in addition to the repeating units of the above formulas (1-a) and (1-b), further a crosslinked structure represented by the following formula (7A) or a crosslinked structure represented by the following formula (8A) is obtained.

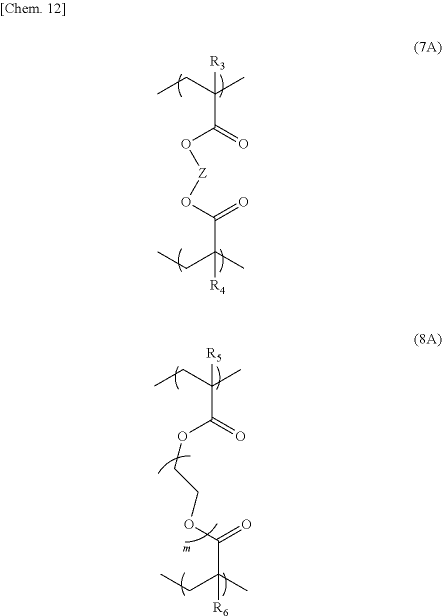

In the formulas (7A) and (8A), R₃ to R₆, Z and n represent the same meanings as R₃ to R₆, Z and n in the formulas (7) and (8).

The copolymer according to the present example embodiment can be used, as an electrode active material, only in a positive electrode, or only in a negative electrode, or in both positive and negative electrodes. Here, the redox potential of the nitroxide radical in the copolymer according to the present example embodiment is nearly 3.6 V vs. Li/Li⁺. This is a relatively high potential; and by using this copolymer for the positive electrode and combining the positive electrode with the low-potential negative electrode, a high-voltage organic radical battery can be obtained. Therefore, it is preferable to use the copolymer according to the present example embodiment as a cathode active material for the positive electrode.

The copolymer according to the present example embodiment is obtained in a gel solid state by polymerization in a solvent. When the copolymer is used as an electrode active material, although usually, the copolymer in a powdery state after the solvent in the gel is removed is used, the copolymer can be used in a gel state as it is for preparation of a slurry.

Then, the constitution of each part of the secondary battery will be described.

(1) Electrode Active Material

An electrode active material using the copolymer according to the present example embodiment can be used in either one of a positive electrode and a negative electrode of the secondary battery, or in both electrodes. In the electrodes (positive electrode, negative electrode) of the secondary battery, the electrode active material according to the present example embodiment can be used alone or in combination with other electrode active materials. In the case of using the electrode active material according to the present example embodiment in combination with other electrode active materials, the electrode active material according to the present example embodiment is contained, per 100 parts by mass of all the electrode active materials, preferably in 10 to 90 parts by mass and more preferably in 20 to 80 parts by mass. In this case, as the other electrode active materials, active materials for positive electrodes and negative electrodes, described below can be used in combination.

In the case of using the electrode active material according to the present example embodiment only for a positive electrode or only for a negative electrode, as active materials for the other electrode containing no electrode active material according to the present example embodiment, conventionally known ones can be utilized.

For example, in the case of using the electrode active material according to the present example embodiment for the positive electrode, as an anode active material, a substance capable of reversible intercalation and deintercalation of lithium ions can be used. Examples of the anode active material include metallic lithium, lithium alloys, carbon materials, conductive polymers and lithium oxides. Examples of the lithium alloys include lithium-aluminum alloys, lithium-tin alloys and lithium-silicon alloys. Examples of the carbon materials include graphite, hard carbon and activated carbon. Examples of the conductive polymers include polyacene, polyacetylene, polyphenylene, polyaniline and polypyrrole. Examples of the lithium oxides include lithium alloys such as lithium aluminum alloys, and lithium titanate.

In the case of using the electrode active material according to the present example embodiment for the negative electrode, as a cathode active material, a substance capable of reversible intercalation and deintercalation of lithium ions can be used. The cathode active material includes lithium-containing composite oxides. Specifically, materials such as LiMO₂ (M is selected from Mn, Fe and Co, and a part of M may be replaced with another metal element such as Mg, Al or Ti), LiMn₂O₄ and olivine-type metal phosphate materials can be used.

Although an electrode using the electrode active material according to the present example embodiment is not limited to either of a positive electrode and a negative electrode, from the viewpoint of the energy density, it is preferable to use the electrode active material as a cathode active material.

(2) Conductivity-Imparting Agent (Auxiliary Conductive Material) and Ionic Conduction Auxiliary Material

The positive electrode and negative electrode, for the purpose of lowering the impedance and improving the energy density and the high power output characteristic, can also be mixed with a conductivity-imparting agent (auxiliary conductive material) and an ionic conduction auxiliary material.

The conductivity-imparting agent includes carbon materials such as graphite, carbon black, acetylene black, carbon fibers and carbon nanotubes, and conductive polymers such as polyaniline, polypyrrole, polythiophene, polyacetylene and polyacene. Among these, the carbon materials are preferable, and specifically, preferable is at least one selected from the group consisting of natural graphite, artificial graphite, carbon black, vapor grown carbon fibers, mesophase pitch carbon fibers and carbon nanotubes. These conductivity-imparting agents may be used by mixing two or more thereof in any proportions within the scope of the gist of the present invention.

The size of the conductivity-imparting agent is not especially limited, and finer ones are preferable from the viewpoint of homogeneous dispersion. For example, with respect to the particle diameter, the average particle diameter of primary particles is preferably 500 nm or smaller; and the diameter in the case of a fiber-form or tube-form material is preferably 500 nm or smaller and the length thereof is preferably 5 nm or longer and 50 μm or shorter. Here, the average particle diameter and each size mentioned here are average values obtained by electron microscopic observation, or D50 values in a particle size distribution measured by a laser diffraction-type particle size distribution analyzer.

The ionic conduction auxiliary material includes polymer gel electrolytes and polymer solid electrolytes.

Among these conductivity-imparting agents and ionic conduction auxiliary materials, it is preferable to mix carbon fibers being a conductivity-imparting agent. Mixing the carbon fibers makes higher the tensile strength of the electrode and makes scarce the cracking and exfoliation in the electrode. More preferably, vapor grown carbon fibers are mixed.

These conductivity-imparting agents and ionic conduction auxiliary materials can also each be used singly or as a mixture of two or more. The proportion of these materials in the electrode is preferably 10 to 80% by mass.

(3) Binder

In order to strengthen binding between each material in the positive electrode and negative electrode, a binder can be used. Such a binder includes resin binders such as polytetrafluoroethylene, polyvinylidene fluoride, vinylidene fluoride-hexafluoropropylene copolymers, vinylidene fluoride-tetrafluoroethylene copolymers, styrene-butadiene copolymerized rubber, polypropylene, polyethylene, polyimide, and various polyurethanes. These binders can be used singly or as a mixture of two or more. The proportion of the binders in the electrode is preferably 5 to 30% by mass.

(4) Thickener

In order to make easy the preparation of a slurry for the electrode, a thickener can also be used. Such a thickener includes carboxymethylcellulose, polyethylene oxide, polypropylene oxide, hydroxyethylcellulose, hydroxypropylcellulose, carboxymethylhydroxyethylcellulose, polyvinyl alcohol, polyacrylamide, hydroxyethyl polyacrylate, ammonium polyacrylate and sodium polyacrylate. These thickeners can be used singly or as a mixture of two or more. The proportion of the thickeners in the electrode is preferably 0.1 to 5% by mass. The thickener further serves as a binder in some cases.

(5) Current Collector

As negative and positive electrode current collectors, those having a shape of a foil, a metal flat plate, a mesh or the like, composed of nickel, aluminum, copper, gold, silver, an aluminum alloy, stainless steel, carbon or the like can be used. Further, the current collector may be made to have a catalytic effect, and the electrode active material and the current collector may also be made to be chemically bound.

(6) Shape of the Secondary Battery

The shape of the secondary battery is not especially limited, and conventionally known ones can be used. The shape of the secondary battery includes shapes in which an electrode stack or a wound body is sealed in a metal case, a resin case, a laminate film composed of a metal foil, such as an aluminum foil, and a synthetic resin film, or the like. Specifically, the secondary battery is fabricated as having a cylindrical, rectangular, coin or sheet shape, but the shape of the secondary battery according to the present example embodiment is not limited to these shapes.

(7) Method for Producing the Secondary Battery

A method for producing the secondary battery is not especially limited, and a method suitably selected according to materials can be used. The method is, for example, such that: a slurry is prepared by adding a solvent to an electrode active material, a conductivity-imparting agent and the like; then, the obtained slurry is applied on an electrode current collector and the solvent is vaporized by heating or at normal temperature to thereby fabricate an electrode; further the electrode is stacked or wound with a counter electrode and a separator interposed therebetween, and are wrapped in outer packages, and an electrolyte is injected; and the outer packages are sealed. The solvent for slurry includes etheric solvents such as tetrahydrofuran, diethyl ether, ethylene glycol dimethyl ether and dioxane; amine-based solvents such as N, N-dimethylformamide and N-methylpyrrolidone; aromatic hydrocarbon-based solvents such as benzene, toluene and xylene; aliphatic hydrocarbon-based solvents such as hexane and heptane; halogenated hydrocarbon-based solvents such as chloroform, dichloromethane, dichloroethane, trichloroethane and carbon tetrachloride; alkyl ketone-based solvents such as acetone and methyl ethyl ketone; alcoholic solvents such as methanol, ethanol and isopropyl alcohol; and dimethyl sulfoxide and water. Further a method for fabricating an electrode also includes a method in which an electrode active material, a conductivity-imparting agent and the like are kneaded in a dry condition, and thereafter made into a thin film and laminated on an electrode current collector. In fabrication of an electrode, particularly in the case of the method in which a slurry is prepared by adding a solvent to an organic electrode active material, a conductivity-imparting agent and the like, and then, the obtained slurry is applied on an electrode current collector and the solvent is vaporized by heating or at normal temperature, exfoliation, cracking and the like of the electrode are liable to occur. The case of fabricating an electrode having a thickness of preferably 40 μm or larger and 300 μm or smaller by using the copolymer according to the present example embodiment as an electrode active material has a feature such that exfoliation, cracking and the like of the electrode hardly occur and a uniform electrode can be fabricated.

When the secondary battery is produced, there are a case where the secondary battery is produced by using, as an electrode active material, the copolymer itself according to the present example embodiment, and a case where the secondary battery is produced by using a polymer which transforms to the copolymer according to the present example embodiment by an electrode reaction. Examples of the polymer which transforms to the copolymer according to the present example embodiment by such an electrode reaction include a lithium salt or a sodium salt composed of nitroxide anions into which nitroxyl radicals have been reduced by reduction of the copolymer represented by the above formula (1) and electrolyte cations such as lithium ions or sodium ions, and a salt composed of oxoammonium cations into which nitroxyl radicals have been oxidized by oxidation of the copolymer represented by the formula (1) and electrolyte anions such as PF₆⁻ or BF₄⁻.

In the present example embodiment, leading-out of terminal from an electrode and other production conditions of outer packages and the like can use methods conventionally known as production methods of secondary batteries.

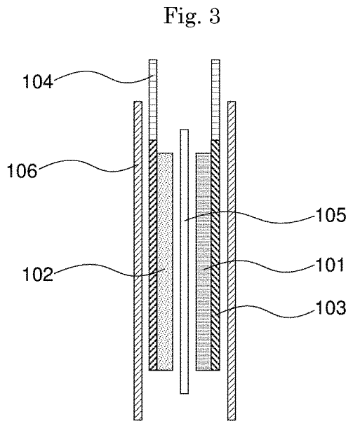

FIG. 2 shows a perspective view of one example of a laminate-type secondary battery according to the present example embodiment; and FIG. 3 shows a cross-sectional view thereof. As shown in these figures, a secondary battery 107 has a stacked structure containing a positive electrode 101, a negative electrode 102 facing the positive electrode, and a separator 105 interposed between the positive electrode and the negative electrode; the stacked structure is covered with outer package films 106; and electrode leads 104 are led out outside the outer package films 106. An electrolyte is injected in the secondary battery. Hereinafter, constituting members and a production method of the laminate-type secondary battery of FIG. 2 will be described in more detail.

Positive Electrode

The positive electrode 101 includes a cathode active material, and as required, further includes a conductivity-imparting agent and a binder, and is formed on one current collector 103.

Negative Electrode

The negative electrode 102 includes an anode active material, and as required, further includes a conductivity-imparting agent and a binder, and is formed on the other current collector 103.

Separator

Between the positive electrode 101 and the negative electrode 102, an insulating porous separator 105 which dielectrically separate these is provided. As the separator 105, a porous resin film composed of polyethylene, polypropylene or the like, a cellulose membrane, a nonwoven fabric or the like can be used.

Electrolyte

The electrolyte transports charge carriers between the positive electrode and the negative electrode, and is impregnated in the positive electrode 101, the negative electrode 102 and the separator 105. As the electrolyte, an electrolyte having an ionic conductivity at 20° C. of 10⁻⁵ to 10⁻¹ S/cm, and a nonaqueous electrolyte in which an electrolyte salt is dissolved in an organic solvent can be used. As the solvent for the electrolyte, an aprotic organic solvent can be used.

As the electrolyte salt, a usual electrolyte material such as LiPF₆, LiClO₄, LiBF₄, LiCF₃SO₃, LiN(CF₃SO₂)₂ (hereinafter, “LiTFSI”), LiN(C₂F₅SO₂)₂ (hereinafter, “LiBETI”), Li(CF₃SO₂)₃C or Li(C₂F₅SO₂)₃C can be used.

Examples of the organic solvent include cyclic carbonates such as ethylene carbonate, propylene carbonate and butylene carbonate; linear carbonates such as dimethyl carbonate, diethyl carbonate and methyl ethyl carbonate; γ-lactones such as γ-butyrolactone; cyclic ether such as tetrahydrofuran and dioxolane; and amides such as dimethylformamide, dimethylacetamide and N-methyl-2-pyrrolidone. As other organic solvents, preferable are organic solvents in which at least one of a cyclic carbonate and a linear carbonate is mixed.

Outer Package Film As the outer package films 106, an aluminum laminate film or the like can be used. Outer packages other than the outer package film include metal cases and resin cases. The outer shape of the secondary battery includes cylindrical, rectangular, coin and sheet shapes.

An Example of Fabricating a Laminate-Type Secondary Battery

A positive electrode 101 was placed on an outer package film 106, and a negative electrode 102 was superimposed thereon through a separator 105 to thereby obtain an electrode stack. The obtained electrode stack was covered with an outer package film 106, and three sides thereof including electrode lead portions were thermally fused. An electrolyte was injected therein and impregnated under vacuum. After the electrolyte was fully impregnated and filled in voids of the electrodes and the separator 105, the remaining fourth side was thermally fused to thereby obtain a laminate-type secondary battery 107.

Here, the “secondary battery” refers to one which can take out an energy electrochemically accumulated, in a form of electric power, and can be charged and discharged. In the secondary battery, a “positive electrode” refers to an electrode whose redox potential is higher, and a “negative electrode” refers to an electrode whose redox potential is conversely lower. The secondary battery according to the present example embodiment is referred to as a “capacitor” in some cases.

### EXAMPLES

Hereinafter, the present invention will be described more specifically by way of Examples, but the present invention is not any more limited to forms shown in Examples.

### Example 1

A fabrication example of an electrode using a copolymer A having a structure of the formula (3) will be described hereinafter.

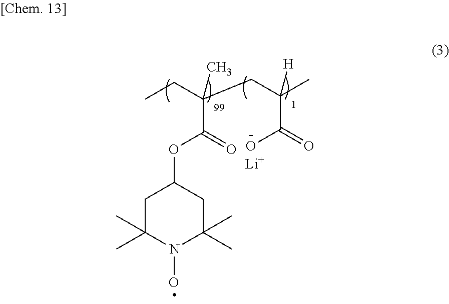

The copolymer A was obtained specifically as follows. 2,2,6,6-tetramethyl-4-piperidyl methacrylate and acrylic acid in a charge ratio of 99:1 were dissolved in tetrahydrofuran, and radically polymerized using AIBN (0.1 mol %) as an initiator at 60° C. for 5 hours to thereby obtain a copolymer of the formula (5) shown in the scheme (II).

Then, the obtained copolymer (5) was oxidized at 60° C. for 8 hours by using a hydrogen peroxide aqueous solution (310 mol %) as an oxidizing agent to thereby obtain a copolymer of the formula (6) shown in the scheme (II). Finally, carboxyl groups of the copolymer represented by the formula (6) were lithiated with a 10-wt % lithium methoxide methanol solution to thereby obtain the copolymer (Mw=270,000) represented by the formula (3) in a red solid state.

2.1 g of the copolymer A, 0.63 g of a vapor grown carbon fiber (VGCF) as a conductivity-imparting agent, 0.24 g of carboxymethylcellulose (CMC) and 0.03 g of a polytetrafluoroethylene (PTFE) as binders, and 15 ml of water were stirred by a homogenizer to thereby prepare a homogeneous slurry. The slurry was applied on an Al foil as a current collector for a positive electrode, and dried at 80° C. for 5 min. The thickness of the electrode was regulated in the range of 140 μm to 150 μm by a roll press machine, as the result, an electrode using the copolymer A was obtained.

### Example 2

A crosslinked copolymer B was obtained as in Example 1, except for, in the radical polymerization in the first step, adding a crosslinking agent of the formula (9) so as to be 1 mol % per 100 mol % in total of 2,2,6,6-tetramethyl-4-piperidyl methacrylate and acrylic acid. An electrode was fabricated as in Example 1, by using the obtained crosslinked copolymer B.

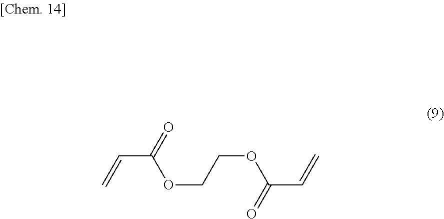

### Example 3

A crosslinked copolymer C was obtained as in Example 2, except for altering the molar ratio of 2,2,6,6-tetramethyl-4-piperidyl methacrylate and acrylic acid to 99.25:0.75. An electrode was fabricated as in Example 1, by using the obtained crosslinked copolymer C.

### Example 4

A crosslinked copolymer D was obtained as in Example 2, except for altering the molar ratio of 2,2,6,6-tetramethyl-4-piperidyl methacrylate and acrylic acid to 98.75:1.25. An electrode was fabricated as in Example 1, by using the obtained crosslinked copolymer D.

### Example 5

Hereinafter, a method for fabricating an organic radical battery using, as a positive electrode, the electrode fabricated by using the copolymer A will be described.

### <Fabrication of a Positive Electrode>

The electrode using the copolymer A fabricated in Example 1 was cut out into a rectangle of 22×24 mm; and then, an Al electrode lead was connected to the Al foil as a current collector for the positive electrode by ultrasonic welding, as the result, a positive electrode for an organic radical battery was obtained.

### <Fabrication of a Negative Electrode>

13.5 g of a graphite powder (particle diameter: 6 μm) as an anode active material, 1.35 g of a polyvinylidene fluoride as a binder, 0.15 g of a carbon black as a conductivity-imparting agent and 30 g of an N-methylpyrrolidone solvent (boiling point: 202° C.) were stirred in a homogenizer to thereby prepare a homogeneous slurry. The slurry was applied on a copper mesh being a negative electrode current collector, and dried at 120° C. for 5 min. Further, the thickness of the electrode was regulated in the range of 50 μm to 55 μm by a roll press machine. An obtained negative electrode was cut out into a rectangle of 22×24 mm; and a nickel electrode lead was connected to the copper mesh by ultrasonic welding. As the result, a negative electrode for the organic radical battery was obtained.

### <Fabrication of a Laminate-Type Battery>

A porous polypropylene film separator was interposed between the positive electrode and the negative electrode to thereby obtain an electrode stack. The electrode stack was covered with aluminum laminate outer packages; and three sides thereof including electrode lead portions were thermally fused. An electrolyte consisting of ethylene carbonate/dimethyl carbonate in 40/60 (v/v) and a LiPF₆ supporting salt of 1.0 mol/L in concentration was injected through the remaining fourth side in the outer packages, allowing the electrodes to be well impregnated with the electrolyte. The amount of the electrolyte contained at this time was regulated so that the molar concentration of the lithium salt became 1.5 times the number of moles of the nitroxyl radical moiety structure. The remaining fourth side was thermally fused under reduced pressure, as the result, a laminate-type organic radical battery was completed.

### <Measurement of the Discharge Characteristic>

The fabricated organic radical battery was charged until the voltage became 4 V and thereafter discharged to 3 V, at a constant current of 0.25 mA in a thermostatic chamber at 20° C.; and then, the discharge characteristic of the organic radical battery was measured.

Evaluation of the high rate discharge characteristic: the battery was charged up to a voltage of 4 V at a constant current of 2.5 mA, and thereafter successively charged at a constant voltage of 4 V until the current became 0.25 mA; thereafter, the battery was discharged at constant currents in varied magnitudes of the discharge current, and the discharge capacities at the times were measured. The above discharges of the constant currents were conducted at three currents of 1 C (2.5 mA), 10 C (25 mA) and 20 C (50 mA). Here, the discharge capacities were, in order to easily compare efficiencies of the radical materials, determined as capacities per weight of the radical materials.

Measurement of the power in pulse discharge: the battery was charged up to a voltage of 4 V at a constant current of 2.5 mA, thereafter successively charged at a constant voltage of 4 V until the current became 0.25 mA; and thereafter successively, the battery was subjected to a 1-sec pulse discharge at varied current values in the range of 10.5 mA to 950 mA, and the voltages at the ends of the discharges were measured. The cell resistance was determined from a slope of a voltage-current curve and the maximum power was determined from maximum value of a current-power (voltage×current) curve. Here, the maximum power was determined as a power per positive electrode area. Evaluation results of the high rate discharge characteristic and measurement results of the power in pulse discharge are shown in Table 1.

### Examples 6 to 8

In the same manner as in Example 5 except for using, as positive electrodes, the electrodes fabricated in Examples 2 to 4 in place of the electrode fabricated in Example 1, organic radical batteries were fabricated and the high rate discharge characteristic and the pulse power characteristic were measured. Results are shown in Table 1.

### Comparative Example 1

An electrode was fabricated by the same method as described in Example 1, except for using PTMA (Mw=89,000, called a polymer E) having a structure of the above-mentioned formula (2). Then, an organic radical battery was fabricated by using a positive electrode fabricated by using the polymer E, and the high rate discharge characteristic and the pulse power characteristic were measured, by the same method as described in Example 5. Results are shown in Table 1.

### Comparative Example 2

An electrode was fabricated by the same method as described in Example 2, except for using no acrylic acid and producing a crosslinked polymer F of PTMA without lithiation. Then, an organic radical battery was fabricated by using a positive electrode fabricated by using the crosslinked polymer F, and the high rate discharge characteristic and the pulse power characteristic were measured, by the same method as described in Example 5. Results are shown in Table 1.

TABLE 1

| | | | Discharge rate | | | Pulse power | |
|---|---|---|---|---|---|---|---|
| | | | properties | | | properties | |
| | | Formula (1-a):Formula | 1 C | 10 C | 20 C | Cell | Maximum |
| | | (1-b) | capacity | capacity | capacity | resistance | power |
| | Radical material | (Mole ratio) | (mAh/g) | (mAh/g) | (mAh/g) | (Ωcm²) | (mW/cm²) |
| Example 5 | Copolymer A | 99:1 | 85 | 70 | 68 | 9.2 | 368 |
| Example 6 | Crosslinked | 99:1 | 86 | 71 | 65 | 9.2 | 365 |
| | copolymer B | | | | | | |
| Example 7 | Crosslinked | 99.25:0.75 | 88 | 70 | 60 | 9.8 | 340 |
| | copolymer C | | | | | | |
| Example 8 | Crosslinked | 98.75:1.25 | 83 | 73 | 66 | 9.5 | 370 |
| | copolymer D | | | | | | |
| Comparative | Polymer E | — | 73 | 56 | 38 | 16.8 | 180 |
| Example 1 | | | | | | | |
| Comparative | Crosslinked | — | 60 | 32 | 21 | 29.8 | 108 |
| Example 2 | copolymer F | | | | | | |

### INDUSTRIAL APPLICABILITY

By using the organic radical battery according to the present invention, a secondary battery having a high discharge characteristic can be provided. Hence, the organic radical battery obtained by the example embodiment can be applied to driving or auxiliary power storage sources for electric cars, hybrid electric cars and the like, power sources for various types of portable electronic devices, power storage apparatuses of various types of energies such as solar energy and wind power generation, power storage sources for household electric devices, and the like.

The present application claims priority based on Japanese Patent Application No. 2017-008484, filed on Jan. 20, 2017, the disclosure of which is hereby incorporated in its entirety.

### REFERENCE SIGNS LIST

101 POSITIVE ELECTRODE
102 NEGATIVE ELECTRODE
103 CURRENT COLLECTOR
104 ELECTRODE LEAD
105 SEPARATOR
106 OUTER PACKAGE FILM
107 LAMINATE-TYPE SECONDARY BATTERY

1. An electrode comprising, as an electrode active material, a copolymer having a repeating unit having a nitroxide radical site represented by the following formula (1-a) and a repeating unit having carboxy-lithium represented by the following formula (1-b) in the range of x satisfying 0.1 to 10: 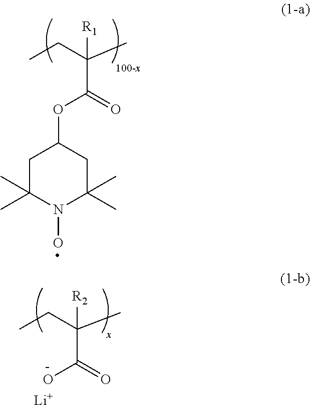
wherein R₁ and R₂ each independently represent hydrogen or a methyl group; and 100−x:x represents a molar ratio of the repeating units in the copolymer.

2. The electrode according to claim 1, wherein the copolymer is a binary copolymer represented by the following formula (1): 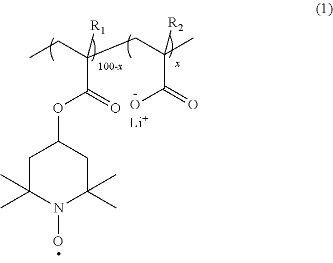
wherein R₁ and R₂ each independently represent hydrogen or a methyl group; and 100−x:x represents a molar ratio of the repeating units in the copolymer, and x is 0.1 to 10.

3. The electrode according to claim 1, wherein the copolymer is a crosslinked copolymer further having a crosslinked structure represented by the following formula (7A) or a crosslinked structure represented by the following formula (8A): 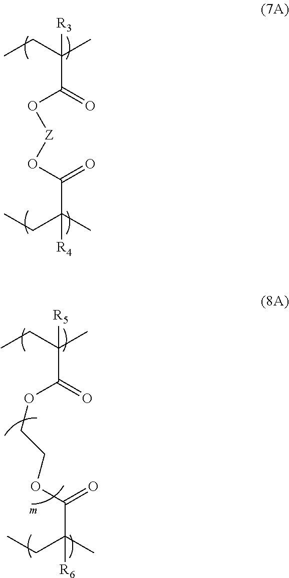
wherein R₃ to R₆ each independently represent hydrogen or a methyl group; Z represents an alkylene chain having 2 to 12 carbon atoms; and n represents an integer of 2 to 12.

4. A secondary battery comprising an electrode according to claim 1 for a positive electrode, for a negative electrode or for both positive and negative electrodes.

5. A secondary battery comprising an electrode according to claim 2 for a positive electrode, for a negative electrode or for both positive and negative electrodes.

6. A secondary battery comprising an electrode according to claim 3 for a positive electrode, for a negative electrode or for both positive and negative electrodes.
